(19) United States
(12) Patent Application Publication
(10) Pub. No.: US 2010/0103432 A1
(43) Pub. Date: Apr. 29, 2010

(54) POSITIONING SYSTEM AND METHOD OF USING SAME

(76) Inventors: William J. McGinnis, Cincinnati, OH (US); Scott A. METRICK, Glenview, IL (US)

Correspondence Address: LADAS & PARRY LLP, 224 SOUTH MICHIGAN AVENUE, SUITE 1600, CHICAGO, IL, 60604, US

(21) Appl. No.: 12/258,656

(22) Filed: Oct. 27, 2008

(51) Int. Cl. G01B 11/14; G06F 15/00; G01J 3/00

(52) U.S. Cl. 356/623; 702/150; 356/51

(57) ABSTRACT

A positioning system having an emitter unit, a plurality of detector units, a computer and a software package is described. The emitter unit is configured to emit an emitter signal. Each detector unit is configured to output a detector signal in response to detecting the emitter signal. The computer is coupled to the emitter unit and to the detector units. The software package is installed in the computer that directs the computer to perform a number of functions such as controlling the emitter unit, controlling the detector units, inputting positional information into the computer, and estimating a relative position of the emitter unit relative to a target site within a given workspace. An associated method is also described in which the method includes the steps of calculating, directing, displaying, estimating, identifying, inputting, inserting, mounting, and obtaining.

### FIELD OF THE INVENTION

The present invention relates to positioning systems, more particularly to a positioning system and associated method for use in accurately and precisely identifying a target site within a workspace.

### DESCRIPTION OF THE PRIOR ART

A wide variety of positioning systems are currently available on the commercial market and an even larger number of these types of systems are known in the art of positioning systems devices, for example the X-ray is a device that provides a physician information concerning positions of broken bones. Another type of positioning system would be radar system that provides location information for such things as airplanes and weather patterns. Yet another type of positioning system is the global positioning system that provides location information for such things as automobiles.

While all of the above-described devices fulfill their respective, particular objectives and requirements, the aforementioned patents do not describe a positioning system having an emitter unit, a plurality of detector units, a computer and a software package is described in which the software package performs a number of functions such as controlling the emitter unit, controlling the detector units, inputting positional information into the computer, and estimating a relative position of the emitter unit relative to a target site within a given workspace. This combination of elements would specifically match the user's particular individual needs of making it possible to provide a means for providing reliable information on the exact location of vertebral levels during surgery. The above-described positioning systems make no provision for an positioning system having an emitter unit, a plurality of detector units, a computer and a software package which performs a number of functions such as controlling the emitter unit, controlling the detector units, inputting positional information into the computer, and estimating a relative position of the emitter unit relative to a target site within a given workspace.

Therefore, a need exists for a new and improved positioning system having an emitter unit, a plurality of detector units, a computer and a software package which performs a number of functions such as controlling the emitter unit, controlling the detector units, inputting positional information into the computer, and estimating a relative position of the emitter unit relative to a target site within a given workspace. In this respect, the positioning system according to the present invention substantially departs from the conventional concepts and designs of the prior art, and in doing so provides a system and a method for the purpose of providing a convenient means for making it possible to accurately and precisely identifying a target site within a workspace.

### SUMMARY OF THE INVENTION

The present system and method of using, according to the principles of the present invention, overcomes a number of the shortcomings of the prior art by providing a novel system and method for use in providing accurate and precise position information for locating a target site within a workspace.

The positioning system includes an emitter unit; a plurality of detector units; a computer; and a software package. The emitter unit is configured to emit an emitter signal. Each detector unit is configured to output a detector signal in response to detecting the emitter signal. The computer is coupled to the emitter unit and to the detector unit. The software package is installed in the computer that directs the computer to perform a number of functions such as controlling the emitter unit, controlling the detector unit, inputting information into the computer, and estimating a relative position of the emitter unit relative to a target site within a workspace. An associated method is also described in which the method includes the steps of calculating, directing, displaying, estimating, identifying, inputting, inserting, mounting, and obtaining.

In view of the foregoing disadvantages inherent in the known type positioning systems now present in the prior art, the present invention provides an improved positioning system, which will be described subsequently in great detail, is to provide a new and improved positioning system which is not anticipated, rendered obvious, suggested, or even implied by the prior art, either alone or in any combination thereof.

To attain this, the present system invention essentially comprises an emitter unit; a plurality of detector units; a computer; and a software package. The present method invention essentially comprises the steps of calculating, directing, displaying, estimating, identifying, inputting, inserting, mounting, and obtaining.

There has thus been outlined, rather broadly, the more important features of the invention in order that the detailed description thereof that follows may be better understood, and in order that the present contribution of the art may be better appreciated.

The invention may also include a tool for attachment either to the detector unit or to the emitter unit.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an aspect of the present invention to provide a new and improved positioning system that has many of the advantages of the prior positioning systems while minimizing a number of their disadvantages.

It is another aspect of the present invention to provide a new and improved positioning system that may be easily and efficiently manufactured and marketed.

An even further aspect of the present invention is to provide a new and improved positioning system that has a low cost of manufacture with regard to both materials and labor, and which accordingly is then susceptible of low prices of sale to the consuming public, thereby making a positioning system economically available to the buying public.

Still another aspect of the present invention is to provide a positioning system that provides in the system and methods of the prior art some of the advantages thererof, while simultaneously overcoming some of the disadvantages normally associated therewith.

Even still another aspect of the present invention is to provide a positioning system having an emitter unit, a plurality of detector units, a computer and a software package is described such that the software package directs the computer to perform a number of functions such as controlling the emitter unit, controlling the detector units, inputting positional information into the computer, and estimating a relative position of the emitter unit relative to a target site within a given workspace.

Lastly, it is an aspect of the present invention to provide a new and improved method of using comprising the steps of calculating, directing, displaying, estimating, identifying, inputting, inserting, mounting, and obtaining.

There has thus been outlined, rather broadly, the more important features of the invention in order that the detailed description thereof that follows may be better understood, and in order that the present contribution of the art may be better appreciated.

Numerous other features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other aspects of the invention, along with the various features of novelty that characterize the invention, are pointed out with particularity in the claims annexed to and forming a part of this disclosure. For a better understanding of the invention, its operating advantages and the specific aspects attained by its uses, reference should be had to the accompanying drawings and description matter in which there are illustrated preferred embodiments of the invention.

### BRIEF DESCRIPTION OF THE DRAWINGS

The invention will be better understood and aspects other than those set forth above will become apparent when consideration is given to the following detailed description thereof. Such description makes reference to the annexed drawings wherein:

FIG. 1 is a perspective view of an embodiment of the positioning system constructed in accordance with the principles of the present invention;

FIG. 2 is a perspective view of another embodiment of the positioning system of the present invention;

FIG. 3A is a side view of a plurality of inactive emitters mounted on a stylized view of a workspace of the present invention;

FIG. 3B is a side view of a plurality of active emitters mounted on a stylized view of a workspace of the present invention;

FIG. 4 is a stylized transparent side view of a workspace showing a target site of the present invention;

FIG. 5 is an intensity profile as a function of time of an emitter signal and two detector signals of the present invention;

FIG. 6 is an intensity profile as a function of time of an emitter signal and a detector signal of the present invention;

FIG. 7 is an intensity profile as a function of time of an emitter signal and a detector signal of the present invention;

FIG. 8 is an intensity profile as a function of time of an emitter signal and a detector signal of the present invention;

FIG. 9 is an intensity profile as a function of time of an emitter signal and a detector signal of the present invention;

FIG. 10 is a logic flow diagram of the present invention; and

FIG. 11 is a logic flow diagram of the present invention.

The same reference numerals refer to the same parts throughout the various figures.

### DETAILED DESCRIPTION OF THE PREFERRED EMBODIMENT

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

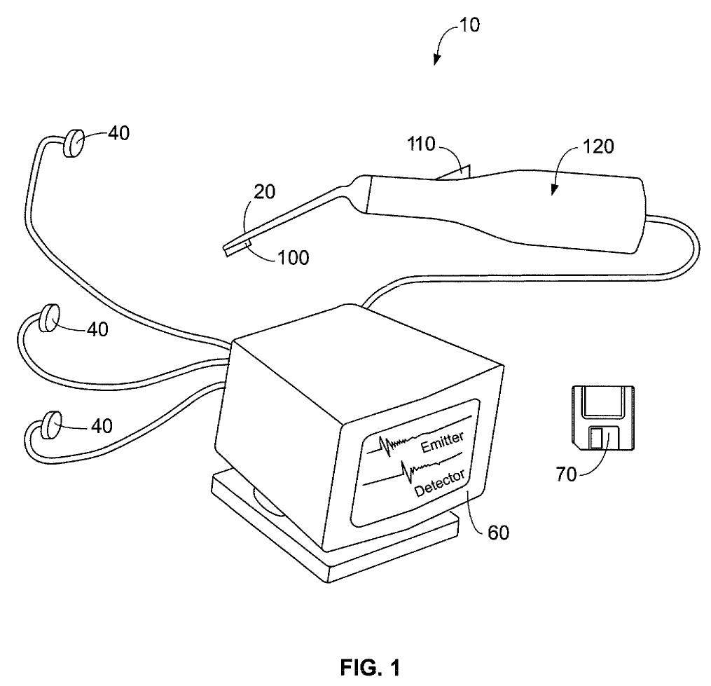

Referring now to the drawings, and in particular FIGS. 1 to 11 thereof, one preferred embodiment of the present invention is shown and generally designated by the reference numeral 10. One preferred embodiment of the positioning system 10 comprises an emitter unit 20, a plurality of detector units 40, a computer 60, and a software package 70. The emitter unit 20 is configured to emit an emitter signal 30. Each of the detector units 40 is configured to output a detector signal 50 in response to detecting the emitter signal 30. The computer 60 is coupled to the emitter unit 20 and to the detector units 40. The software package 70 is installed in the computer 60. The software package 70 is configured to direct the computer 60 to output a control signal that controls the emitter unit 20 to emit the emitter signal 30. The software package 70 is also configured to direct the computer 60 to receive and to store the outputted detector signals 50 from the detector units 40. The software package 70 is also configured to direct the computer 60 to enable inputting placement data of the detector units 40 and position data of a target site 80. Also the software package 70 is configured to direct the computer 60 to estimate a triangulated position of the emitter unit 20 relative to the placement of the detector units 40. Further, the software package 70 is configured to direct the computer 60 to estimate a relative position of the emitter unit 20 relative to the target site 80. Finally, the software package 70 is configured to direct the computer 60 to display the relative position of the emitter unit 20 relative to the target site 80.

The detector units 40 may be any known detector units 40 such as those selected from the group consisting of an infrared detector unit 40, a light detector unit 40, an ultraviolet detector unit 40, an infrasound detector unit 40, an ultrasonic detector unit 40, an X-ray detector unit 40, a radar beam detector unit 40, and a gamma-ray detector unit 40.

The emitter unit 20 may be any known emitter unit 20 such as those selected from the group consisting of a light emitter unit 20, an infrared emitter unit 20, an ultraviolet emitter unit 20, an infrasound emitter unit 20, an ultrasonic emitter unit 20, an X-ray emitter unit 20, a radar beam emitter unit 20, and a gamma-ray emitter unit 20. A more preferred embodiment of the emitter unit 20 is that is an ultrasonic emitter unit 20 selected from the group consisting of a piezoelectric ultrasonic emitter unit 20, a magnetostriction ultrasonic emitter unit 20, and a capacative actuation ultrasonic emitter unit 20. A most preferred embodiment is that the emitter unit 20 is a piezoelectric ultrasonic emitter unit 20.

The shape and form of the emitter signal 30 may be any known morphology such as those selected from the group consisting of a discrete pulse emitter signal 30, an amplitude modulated pulse emitter signal 30, a frequency modulated pulse emitter signal 30, a continuous pulse emitter signal 30, a discrete wave emitter signal 30, an amplitude modulated wave emitter signal 30, a frequency modulated wave emitter signal 301 and a continuous wave emitter signal 30.

An optional tool 100 may be added to the positioning system 10 in which the optional tool 100 is attached to the emitter unit 20. The optional tool 100 may be any commercially available tool 100 such as those tools 100 selected from the group consisting of a scalpel tool 100, a knife tool 100, a pliers tool 100, a hammer tool 100, a screwdriver tool 100, a screw tool 100, a hemostat tool 100, a saw tool 100, a camera tool 100, a needle tool 100, a vacuum tube tool 100, a syringe tool 100, and a light emitting tool 100.

One mode of determining distances is that the software package 70 is configured to use timed differences between when the emitter signal 30 was emitted and when the detector signals 50 were received to estimate distances between the emitter unit 20 and the detector units 40. Another mode of determining distances is that the software package 70 can be configured to use attenuation changes in intensity of the emitter signal 30 to estimate distances between the emitter unit 20 and the detector units 40. Depending on the emitter signal 30 and the media of the workspace 90, the attenuation changes in intensity of the emitter signal 30 are proportional to an inverse square function of the distances between the emitter unit 20 and the detector units 40.

Another preferred embodiment of the positioning system 10 comprises: a plurality of emitter units 20, a detector unit 40, a computer 60, and a software package 70. Each emitter unit 20 is configured to emit a corresponding emitter signal 30. The detector unit 40 is configured to output a plurality of detector signals 50 in response to detecting the emitter signals 30. The computer 60 is coupled to the emitter units 20 and to the detector unit 40. The software package 70 may or may not be installed in the computer 60. The software package 70 is configured to direct the computer 60 to output control signals that control the emitter units 20 to emit the emitter signals 30. The software package 70 is also configured to direct the computer 60 to receive and to store the outputted detector signals 50 from the detector unit 40. The software package 70 is also configured to direct the computer 60 to enable inputting placement data of the emitter units 20 and position data of a target site 80. Also the software package 70 is configured to direct the computer 60 to estimate a triangulated position of the detector unit 40 relative to the placement of the emitter units 20, Further the software package 70 is configured to direct the computer 60 to estimate a relative position of the detector unit 40 relative to the target site 80. Finally the software package 70 is configured to direct the computer 60 to display the relative position of the detector unit 40 relative to the target site 80.

An optional tool 100 also may be added to this preferred embodiment of the positioning system 10 by attaching it to the detector unit 40. The optional tool 100 is may be selected from the group consisting of a scalpel tool 100, a knife tool 100, a pliers tool 100, a hammer tool 100, a screwdriver tool 100, a hemostat tool 100, a saw tool 100, a camera tool 100, a needle tool 100, a vacuum tube tool 100, a syringe tool 100, and a light emitting tool 100.

Yet another preferred embodiment of the positioning system 10 comprises: a detector unit 40, a plurality of emitter units 20, a computer 60, and software package 70. The detector unit 40 is configured to output an emission signal and to detect a plurality of reflected signals. Each of the emitter units 20 is configured to reflect a portion of the outputted emission signal. The computer 60 is coupled to the detector unit 40. The software package 70 is installed in the computer 60. The software package 70 is configured to direct the computer 60 to output a control signal that controls the detector unit 40 to emit the emission signal. The software package 70 is also configured to direct the computer 60 to input the reflected signals detected at the detector unit 40. The software package 70 is also configured to direct the computer 60 to enable inputting placement data of the emitter units 20. The software package 70 is also configured to direct the computer 60 to enable inputting placement data of the emitter units 20 and position data of a target site 80. Also the software package 70 is configured to direct the computer 60 to estimate a triangulated position of the detector unit 40 relative to the placement of the emitter units 20. Further the software package 70 is configured to direct the computer 60 to estimate a relative position of the detector unit 40 relative to the target site 80. Finally the software package 70 is configured to direct the computer 60 to display the relative position of the detector unit 40 relative to the target site 80. In this preferred embodiment the detector unit 40 may be selected from the group consisting of a radar beam transducer detector unit 40 and an ultrasonic transducer detector unit 40.

A preferred embodiment of a method of estimating a relative position within a workspace 90, the method comprises the steps of: calculating, directing, displaying, estimating, identifying, inputting, inserting, mounting, and obtaining. The obtaining step comprises obtaining a positioning system 10 comprising: an emitter unit 20 configured to emit an emitter signal 30; a plurality of detector units 40, each detector unit 40 is configured to output a detector signal 50 in response to detecting the emitter signal 30; a computer 60 coupled to the emitter unit 20 and to the detector units 40; and software package 70 installed in the computer 60, wherein the software package 70 is configured to direct the computer 60 to output a control signal that controls the emitter unit 20 to emit the emitter signal 30, the software package 70 is configured to direct the computer 60 to receive and to store the outputted detector signals 50 from the detector units 40, the software package 70 is configured to direct the computer 60 to enable inputting placement data of the detector units 40 and position data of a target site 80, the software package 70 is configured to direct the computer 60 to estimate a triangulated position of the emitter relative to the placement of the detector units 40, the software package 70 is configured to direct the computer 60 to estimate a relative position of the emitter unit 20 relative to the target site 80, and the software package 70 is configured to direct the computer 60 to display the relative position of the emitter unit 20 relative to the target site 80. The mounting step comprises mounting precisely each detector unit 40 at various chosen locations in or around the workspace 90. The inputting step comprises inputting into the computer 60 placement data of the mounted detector units 40 and position data of the target site 80. The directing step comprises directing the computer 60 to output the control signal that controls the emitter unit 20 to emit the emitter signal 30. The inserting step comprises inserting the emitter unit 20 within the workspace 90. The calculating step comprises calculating a triangulated position of the emitter unit 20 relative to the mounted detector units 40 using information from the detected emitter signals 30 detected by the mounted detector units 40. The estimating step comprises estimating a relative position of the emitter unit 20 relative to the target site 80 using the triangulated position. The displaying step comprises displaying the estimated relative position of the emitter unit 20 information from the computer 60 that estimates a distance of the emitter unit 20 relative to the target site 80. The identifying step comprises identifying the target site 80 using the received information.

An optional set of steps may be added to the method that further comprising the steps of: choosing, converting, determining, making, and using. The making step comprises making front and side view X-rays of a portion of the workspace 90. The choosing step comprises choosing various mounting sites in or around the workspace 90. The using step comprises using the X-rays to identify raw positions of the mounting sites and the target site 80. The determining step comprises determining an enlargement factor of the X-rays. The converting step comprises converting the raw positions into corrected positions to accommodate for the enlargement factor of the X-rays.

The target site 80 may be any known target site 80 such as those selected from the group consisting of a surgical target site 80, a semiconductor wafer alignment target site 80, a manufacture target site 80, and a waste disposal target site 80. A most preferred target site 80 is that it is a cervical level spinal target site 80.

Referring now to FIG. 1 is a perspective view depiction of an embodiment of the positioning system 10 of the present invention. The positioning system 10 is shown comprising an emitter unit 20, a plurality of detector units 40, a computer 60, and a software package 70. Also shown is the optional tool 100 attached to the emitter unit 20. Also shown is a trigger switch 110 controlling the emitter unit 20 and a handle 120 mounted onto the emitter unit 20.

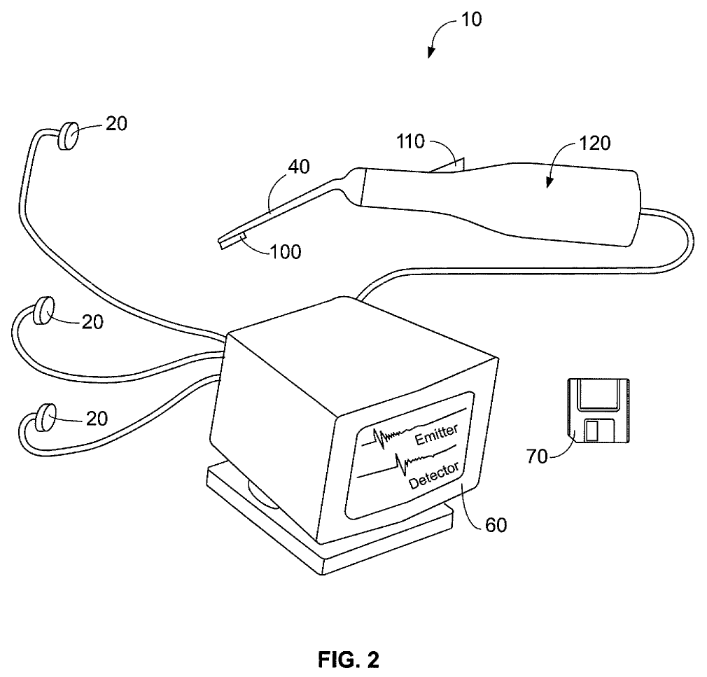

Referring now to FIG. 2 is a perspective view depiction of another embodiment of the positioning system 10 of the present invention. The positioning system 10 is shown comprising a plurality of emitter units 20, a detector unit 40, a computer 60, and a software package 70. Also shown is the optional tool 100 attached to the detector unit 40. Also shown is a trigger switch 110 controlling the detector unit 40 and a handle 120 mounted onto the detector unit 40.

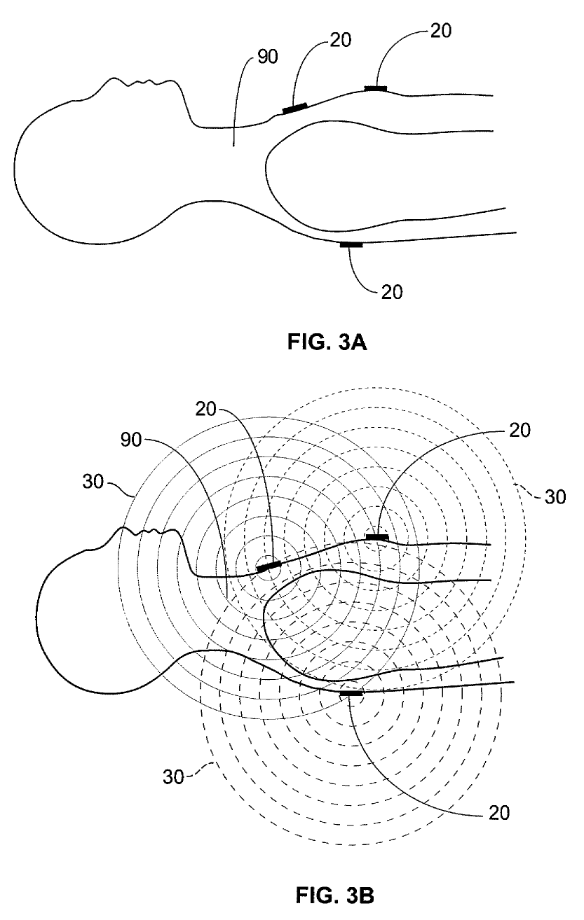

Referring now to FIG. 3A, a plurality of inactive emitter units 20 is shown mounted on a stylized side view of a workspace 90 of the present invention.

Referring now to FIG. 3B, a plurality of active emitter units 20 is shown mounted on a stylized side view of a workspace 90 in which the active emitter units 20 are also shown emitting their respective emitter signals 30.

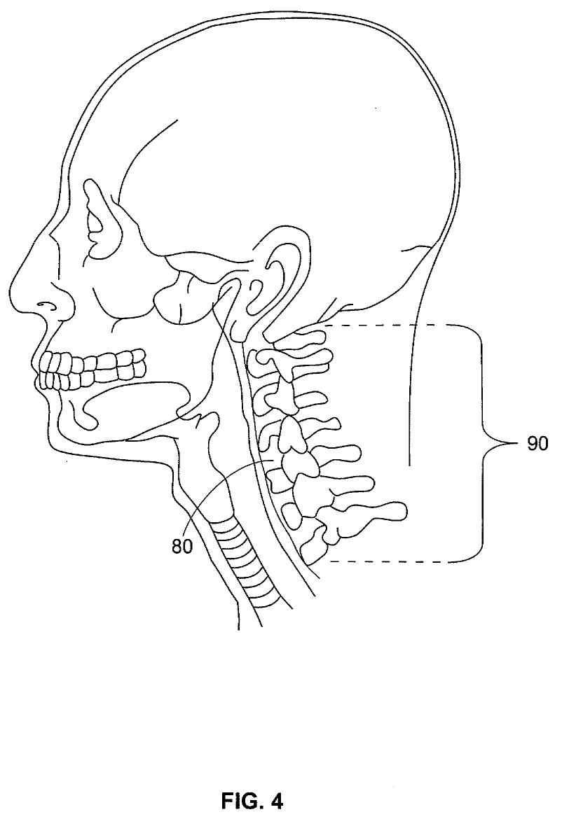

Referring now to FIG. 4, a stylized transparent side view of a workspace 90 is shown as well as a target site 80 is shown in the workspace 90.

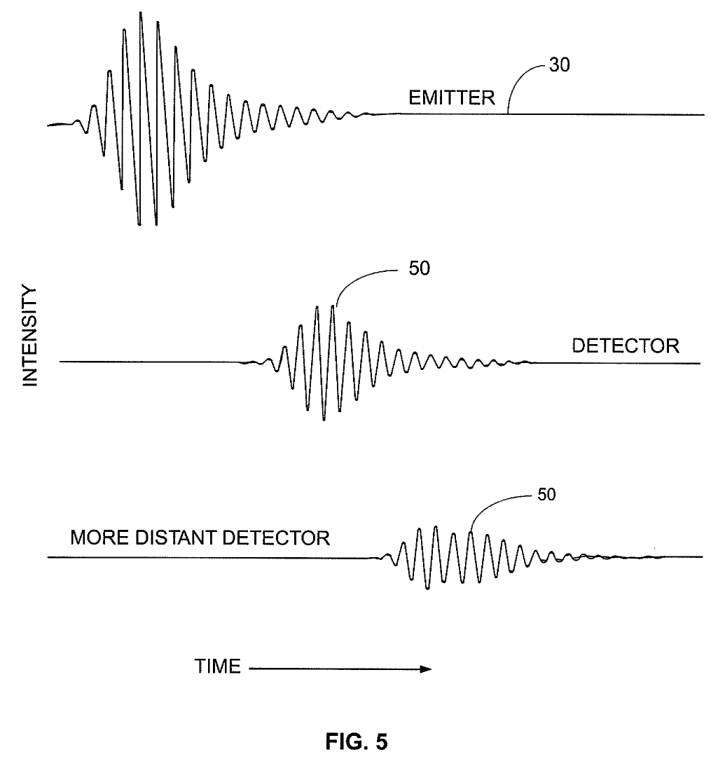

Referring now to FIG. 5, an intensity profile as a function of time is shown depicting a discontinuous amplitude modulated wave emitter signal 30 and two detector signals 50 in which one of the detector units 40 is more distant from the emitter.

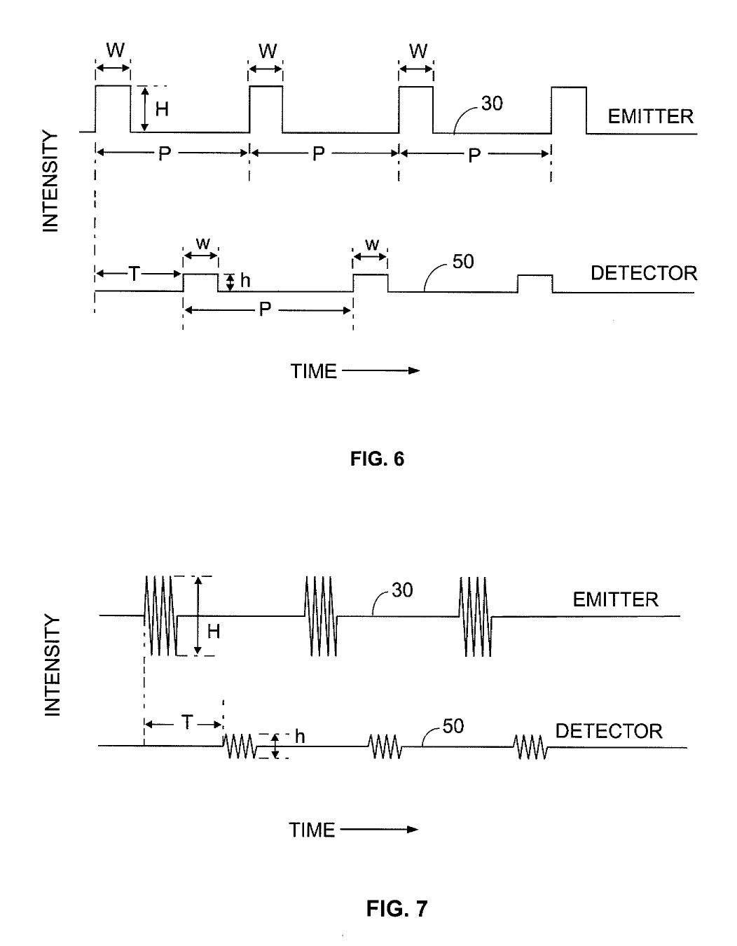

Referring now to FIG. 6, an intensity profile as a function of time is shown depicting a continuous pulse emitter signal 30 and a corresponding detector signal 50 of the present invention. The emitter signal 30 is shown having a width W, a height, H and a cycle and a period P. The detector signal 50 is shown having a width w and a period p approximately equal to the width W and period P of the emitter signals 30. The detector signal 50 is shown having an attenuated height h smaller than the height H of the emitter signal 30. The detector signal 50 is also shown having a delay time T relative to the emitter signal 30.

Referring now to FIG. 7, an intensity profile as a function of time is shown depicting a discontinuous trigonal wave emitter signal 30 and a corresponding detector signal 50 of the present invention.

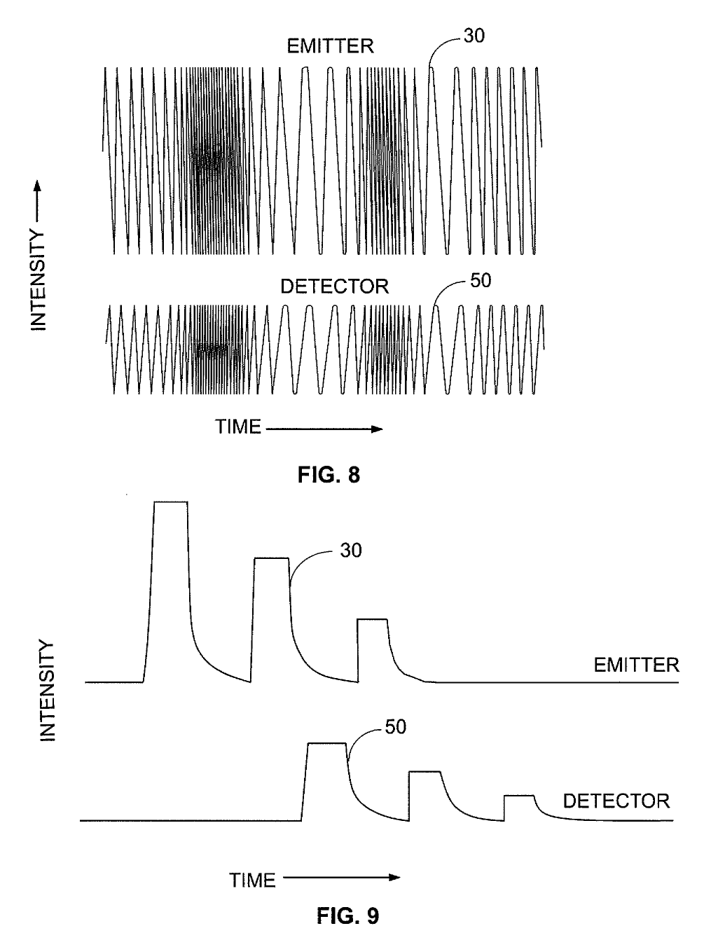

Referring now to FIG. 8, an intensity profile as a function of time is shown depicting a continuous frequency modulated emitter signal 30 and a corresponding detector signal 50 of the present invention.

Referring now to FIG. 9, an intensity profile as a function of time is shown depicting a discontinuous asymmetric pulse emitter signal 30 and a corresponding detector signal 50 of the present invention.

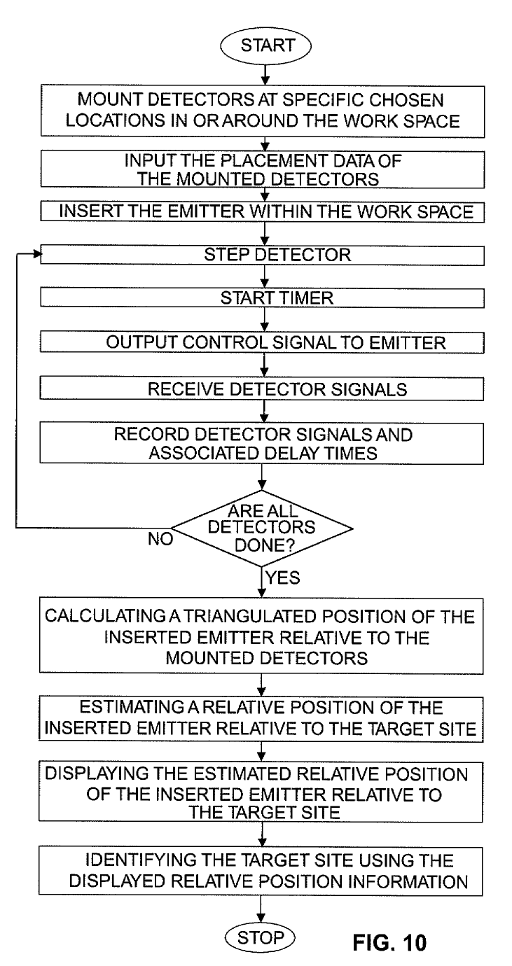

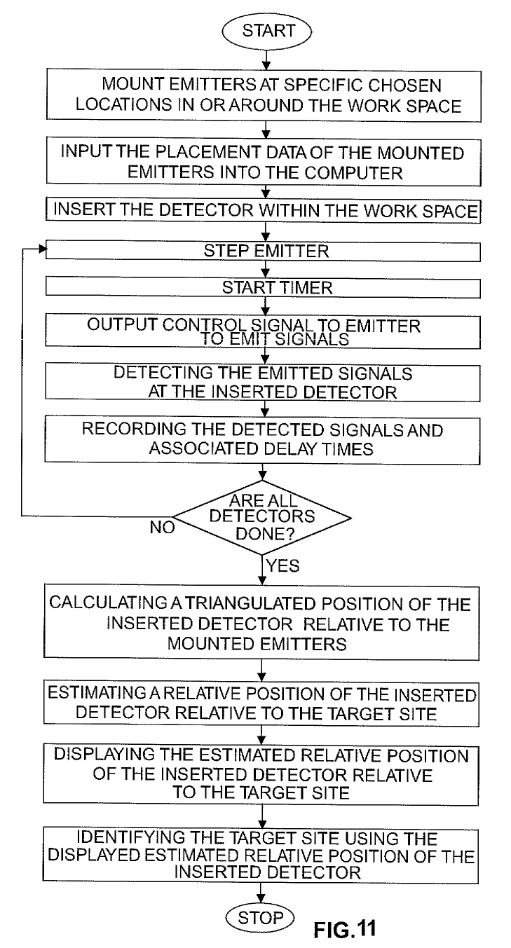

Referring now to FIG. 10, a logic flow diagram of the present invention is shown depicted for the preferred embodiment that comprises a plurality of detector units 40 and a single emitter unit 20.

Referring now to FIG. 11, a logic flow diagram of the present invention is shown for the preferred embodiment that comprises a plurality of emitter units 20 and a single detector unit 40.

As to the manner of usage and operation of the present invention, the same should be apparent from the above description. Accordingly, no further detailed discussion relating to the manner of usage and operation will be provided.

While a preferred embodiment of the positioning system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Accordingly, the detailed discussion herein of one or more embodiments is not intended, nor is to be construed, to limit the metes and bounds of the patent protection afforded the present invention, in which the scope of patent protection is intended to be defined by the claims and their equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although steps of various the claimed method may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

Those skilled in the art will appreciate that the invention described herein is susceptible to variations and modifications other than those specifically described. It is to be understood that the invention includes all such variations and modification which fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A positioning system comprising:
an emitter unit configured to emit an emitter signal;
a plurality of detector units, each detector unit is configured to output a detector signal in
response to detecting the emitter signal;
a computer coupled to the emitter unit and to the detector units; and
a software package installed in the computer, wherein
the software package is configured to direct the computer to output a control signal that controls the emitter unit to emit the emitter signal,
the software package is configured to direct the computer to receive and to store the outputted detector signals from the detector units,
the software package is configured to direct the computer to enable inputting placement data of the detector units and position data of a target site,
the software package is configured to direct the computer to estimate a triangulated position of the emitter unit relative to the placement of the detector units,
the software package is configured to direct the computer to estimate a relative position of the emitter unit relative to the target site, and
the software package is configured to direct the computer to display the relative position of the emitter unit relative to the target site.

2. The system of claim 1 further comprising a tool attached to the emitter unit.

3. The system of claim 2 wherein the tool is selected from the group consisting of a scalpel tool, a knife tool, a pliers tool, a hammer tool, a screwdriver tool, a screw tool, a hemostat tool, a saw tool, a camera tool, a needle tool, a vacuum tube tool, a syringe tool, and a light emitting tool.

4. The system of claim 1 wherein the emitter signal is selected from the group consisting of a discrete pulse emitter signal, an amplitude modulated pulse emitter signal, a frequency modulated pulse emitter signal, a continuous pulse emitter signal, a discrete wave emitter signal, an amplitude modulated wave emitter signal, a frequency modulated wave emitter signal, and a continuous wave emitter signal.

5. The system of claim 1 wherein the emitter unit is selected from the group consisting of a light emitter unit, an infrared emitter unit, an ultraviolet emitter unit, a infrasound emitter unit, an ultrasonic emitter unit, an X-ray emitter unit, a radar beam emitter unit, and a gamma-ray emitter unit.

6. The system of claim 1 wherein anyone of the detector units is selected from the group consisting of an infrared detector unit, a light detector unit, an ultraviolet detector unit, an infrasound detector unit, an ultrasonic detector unit, an X-ray detector unit, a radar beam detector unit, and a gamma-ray detector unit.

7. The system of claim 1 wherein the emitter unit is an ultrasonic emitter unit selected from the group consisting of a piezoelectric ultrasonic emitter unit, a magnetostriction ultrasonic emitter unit, and a capacative actuation ultrasonic emitter unit.

8. The system of claim 1 wherein the software package uses timed differences between when the emitter signal was emitted and when the detector signals were received to estimate distances between the emitter unit and the detector units.

9. The system of claim 1 wherein the software package uses attenuation changes in intensity of the emitter signal to estimate distances between the emitter unit and the detector units.

10. The system of claim 9 wherein the attenuation changes in intensity of the emitter signal are proportional to an inverse square function of the distances between the emitter unit and the detector units.

11. A positioning system comprising:
a plurality of emitter units, each emitter unit is configured to emit a corresponding emitter signal;
a detector unit configured to output a plurality of detector signals in response to detecting the emitter signals;
a computer coupled to the emitter units and to the detector unit; and
a software package installed in the computer, wherein
the software package is configured to direct the computer to output control signals that control the emitter units to emit the emitter signals,
the software package is configured to direct the computer to receive and to store the outputted detector signals from the detector unit,
the software package is configured to direct the computer to enable inputting placement data of the emitter units and position data of a target site,
the software package is configured to direct the computer to estimate a triangulated position of the detector unit relative to the placement of the emitter units,
the software package is configured to direct the computer to estimate a relative position of the detector unit relative to the target site, and
the software package is configured to direct the computer to display the relative position of the detector unit relative to the target site.

12. The system of claim 11 further comprising a tool attached to the detector unit.

13. The system of claim 12 wherein the tool is selected from the group consisting of a scalpel tool, a knife tool, a pliers tool, a hammer tool, a screwdriver tool, a hemostat tool, a saw tool, a camera tool, a needle tool, a vacuum tube tool, a syringe tool, and a light emitting tool.

14. The system of claim 11 wherein the emitter signal is selected from the group consisting of a discrete pulse emitter signal, an amplitude modulated pulse emitter signal, a frequency modulated pulse emitter signal, a continuous pulse emitter signal, a discrete wave emitter signal, an amplitude modulated wave emitter signal, a frequency modulated wave emitter signal, and a continuous wave emitter signal.

15. The system of claim 11 wherein anyone of the emitter units is selected from the group consisting of a light emitter unit, an infrared emitter unit, an ultraviolet emitter unit, a infrasound emitter unit, an ultrasonic emitter unit, an X-ray emitter unit, a radar beam emitter unit, and a gamma-ray emitter unit.

16. The system of claim 11 wherein the detector unit is selected from the group consisting of an infrared detector unit, a light detector unit, an ultraviolet detector unit, an infrasound detector unit, an ultrasonic detector unit, an X-ray detector unit, a radar beam detector unit, and a gamma-ray detector unit.

17. The system of claim 11 wherein anyone of the emitter units is an ultrasonic emitter unit selected from the group consisting of a piezoelectric ultrasonic emitter unit, a magnetostriction ultrasonic emitter unit, and a capacative actuation ultrasonic emitter unit.

18. The system of claim 11 wherein the software package uses timed differences between when the emitter signals were emitted and when the detector signals were received to estimate distances between the emitter units and the detector unit.

19. The system of claim 11 wherein the software package uses attenuation changes in intensity of the emitter signals to estimate distances between the emitter units and the detector unit.

20. The system of claim 19 wherein the attenuation changes in intensity of the emitter signal is proportional to an inverse square function of the distances between the emitter unit and the detector units.

21. A positioning system comprising:
a detector unit configured to output an emission signal and to detect a plurality of reflected signals;
a plurality of emitter units, each emitter unit is configured to reflect a portion of the outputted emission signal;
a computer coupled to the detector unit; and
software package installed in the computer, wherein
the software package is configured to direct the computer to output a control signal that controls the detector unit to emit the emission signal,
the software package is configured to direct the computer to input the reflected signals detected at the detector unit,
the software package is configured to direct the computer to enable inputting placement data of the emitter units,
the software package is configured to direct the computer to enable inputting placement data of the emitter units and position data of a target site,
the software package is configured to direct the computer to estimate a triangulated position of the detector unit relative to the placement of the emitter units,
the software package is configured to direct the computer to estimate a relative position of the detector unit relative to the target site, and
the software package is configured to direct the computer to display the relative position of the detector unit relative to the target site.

22. The system of claim 21 wherein the detector unit is selected from the group consisting of a radar beam transducer detector unit and an ultrasonic transducer detector unit.

23. A method of estimating a relative position within a workspace, the method comprises the steps of:
obtaining a positioning system comprising:
an emitter unit configured to emit an emitter signal;
a plurality of detector units, each detector unit is configured to output a detector signal in response to detecting the emitter signal;
a computer coupled to the emitter unit and to the detector units; and
software package installed in the computer, wherein
the software package is configured to direct the computer to output a control signal that controls the emitter unit to emit the emitter signal,
the software package is configured to direct the computer to receive and to store the outputted detector signals from the detector units,
the software package is configured to direct the computer to enable inputting placement data of the detector units and position data of a target site,
the software package is configured to direct the computer to estimate a triangulated position of the emitter relative to the placement of the detector units,
the software package is configured to direct the computer to estimate a relative position of the emitter unit relative to the target site, and
the software package is configured to direct the computer to display the relative position of the emitter unit relative to the target site;
mounting precisely each detector unit at various chosen locations in or around the workspace;
inputting into the computer placement data of the mounted detector units and position data of the target site;
directing the computer to output the control signal that controls the emitter unit to emit the emitter signal;
inserting the emitter unit within the workspace;
calculating a triangulated position of the emitter unit relative to the mounted detector units using information from the detected emitter signals detected by the mounted detector units;
estimating a relative position of the emitter unit relative to the target site using the triangulated position;
displaying the estimated relative position of the emitter unit information from the computer that estimates a distance of the emitter unit relative to the target site; and
identifying the target site using the received information.

24. The method of claim 23 further comprising the steps of:
making front and side view X-rays of a portion of the workspace;
choosing various mounting sites in or around the workspace;
using the X-rays to identify raw positions of the mounting sites and the target site;
determining an enlargement factor of the X-rays; and
converting the raw positions into corrected positions to accommodate for the enlargement factor of the X-rays.

25. The method of claim 23 wherein the target site is selected from the group consisting of a surgical target site, a semiconductor wafer alignment target site, a manufacture target site, and a waste disposal target site.

26. The method of claim 23 wherein the target site is a cervical level spinal target site.
